(19) United States
(12) Patent Application Publication
(10) Pub. No.: US 2023/0302875 A1
(43) Pub. Date: Sep. 28, 2023

(54) HEAT STORAGE HEAT PUMP HEATER

(71) Applicant: MAHLE International GmbH, Stuttgart (DE)

(72) Inventors: Yanping Xia, Buffalo, NY (US); Lindsey Lee Leitzel, Lockport, NY (US); Gary Scott Vreeland, Medina, NY (US); Timothy D. Craig, Venice, FL (US); Edward Wolfe, IV, Clarence Center, NY (US)

(21) Appl. No.: 17/701,743

(22) Filed: Mar. 23, 2022

(51) Int. Cl. B60H 1/00; B60H 1/22; F24H 7/02; F28D 20/02

(52) U.S. Cl. CPC B60H 1/00892; B60H 1/22; F24H 7/02; F28D 20/021; B60H 1/00392; B60H 2001/2237

(57) ABSTRACT

A heat storage heat pump heater (HSHPH) incorporated into a heating, ventilation, and air conditioning (HVAC) system that provides heat to maintain the temperature in a compartment (e.g., a cabin of an electric vehicle) during both a heating cycle and defrosting cycle. This HSHPH contains a heat exchanger having an inlet and an outlet located in one or more manifolds and a core that includes one or more refrigerant tubes through which a refrigerant flows and a plurality of fins that extend between the tubes, the one or more refrigerant tubes being in fluid communication with the inlet and the outlet; and a phase change material (PCM) configured to store heat transferred from the refrigerant during a heating cycle and to transfer heat to the refrigerant during a defrosting cycle. The PCM changes phase at a temperature that is greater than or equal to 24° C.

### FIELD

This disclosure relates generally to an automotive heating, ventilation, and air conditioning (HVAC) module or system. More specifically, this disclosure relates to a heat pump heater used in an HVAC module.

### BACKGROUND

The statements in this section merely provide background information related to the present disclosure and may not constitute prior art.

Automotive HVAC modules for electric cars rely on battery power to provide cabin heating through the incorporation of an electrical heater, such as a Positive Temperature Coefficient (PTC) heater. An alternative to using an electric heater is to incorporate a heat pump heater into the design of the module. Such an HVAC module is configured to allow the heat pump heater to function as a condenser in order to provide hot air to the cabin, while an outside heat exchanger acts as an evaporator to draw heat from the ambient air. The use of a heat pump heater in an HVAC system requires less battery power than an electrical heater. However, when the temperature of the ambient air is at or near 0° C. (32° F.), frost will build up on the outside of the heat exchanger due to condensation of moisture in the air. In this situation, the HVAC system will need to undergo a defrosting cycle in order to regenerate the ability of the heat exchanger to perform properly. The occurrence of this defrosting cycle routinely interrupts the normal cabin heating operation, thereby causing a reduction in the amount of heat supplied to the cabin.

A typical solution to prevent such a reduction in the supply of heat is to incorporate a back-up heat source in the HVAC system in order to maintain cabin comfort. However, the incorporation of such a back-up heater requires greater consumption of battery power, thereby, reducing the overall driving range for the electric vehicle. In addition, the use of a back-up electrical heater effectively increases overall system cost and complexity, as well as decreases the energy efficiency associated with the HVAC system.

### SUMMARY

The present disclosure generally provides a heat storage heat pump heater (HSHPH) for use in a heating, ventilation, and air conditioning (HVAC) system to maintain temperature in a compartment, such as the cabin in an electric vehicle (EV). This HSHPH generally comprises a heat exchanger having an inlet and an outlet located in one or more manifolds and a core that includes one or more refrigerant tubes through which a refrigerant flows and a plurality of fins that extend between the tubes, the one or more refrigerant tubes being in fluid communication with the inlet and the outlet; and a phase change material (PCM) configured to store heat transferred from the refrigerant flowing through the refrigerant tubes during a heating cycle and to transfer heat to the refrigerant during a defrosting cycle. The HSHPH provides heat to the compartment during both the heating cycle and the defrosting cycle in order to maintain the temperature in the compartment.

The phase change material (PCM) is a material that changes phase at a temperature that is greater than or equal to 24° C. The PCM may be an organic material or a salt hydrate.

According to one aspect of the present disclosure, the refrigerant is a 2-phase refrigerant and the HSHPH is configured to undergo a thermal siphon-like operation during the defrosting cycle until all of the stored heat in the PCM is depleted or until the defrosting cycle is completed.

According to another aspect of the present disclosure, the PCM is located between the refrigerant tubes in the core and the inlet and/or outlet in the one or more manifolds, such that the PCM is in thermal communication with the refrigerant flowing through the refrigerant tubes. Alternatively, the PCM may be located in a cartridge sandwiched between the refrigerant tubes and/or fins in the core of the heat exchanger, provided that the PCM is in thermal communication with the refrigerant flowing through the refrigerant tubes. Alternatively, the PCM may be located in a composite tube or in composite plates, such that the composite tube surrounds at least a portion of the refrigerant tubes or the composite plates sandwich at least a portion of the refrigerant tubes; wherein the PCM is in thermal communication with the refrigerant flowing through the refrigerant tubes. In general, the PCM is located outside the airflow area of the heat exchanger and does not affect overall air pressure drop associated with the heat exchanger.

According to another aspect of the present disclosure, an HVAC system for maintaining temperature in a compartment is provided. This HVAC system generally comprises: one or more refrigerant tubes through which a refrigerant flows; an outside heat exchanger, wherein ambient air is drawn through the outside heat exchanger by a first blower or fan; at least one expansion valve; a compressor; a three-way valve or similar mechanism; and a HSHPH as described above and further defined herein. Heated air is forced through the HSHPH and provided to the compartment by a second blower or fan. The HVAC system is configured to undergo a heating cycle and a defrosting cycle, such that the HSHPH provides heat to the compartment during both the heating cycle and the defrosting cycle.

According to another aspect of the present disclosure, during the heating cycle the 3-way valve is configured to allow refrigerant to flow from the expansion valve and the outside heat exchanger through the compressor to the HSHPH in order to heat the air provided to the compartment and to transfer heat to the phase change material (PCM) in the HSHPH. During the defrosting cycle, the 3-way valve or similar mechanism is configured to allow refrigerant to flow from the outside heat exchanger through the expansion valve, compressor, and back to the outside heat exchanger. In addition, during the defrosting cycle, the PCM transfers heat to air that passes through the heat exchanger in the HSHPH in order to maintain the temperature in the compartment. This compartment may be the cabin in an electric vehicle (EV).

According to another aspect of the present disclosure, a method of maintaining temperature in a compartment is provided. This method generally comprises: providing an HVAC system that includes an HSHPH as described above and further defined herein; allowing the HVAC system to undergo a heating cycle; and allowing the HVAC system to undergo a defrosting cycle. The HSHPH provides heat to the compartment during both the heating cycle and the defrosting cycle.

According to another aspect of the present disclosure, the heating cycle comprises: drawing ambient air through an outside heat exchanger, such that heat is transferred to a refrigerant flowing there through; allowing the refrigerant to flow through an expansion valve and a compressor in order to further heat the refrigerant; configuring a 3-way valve or like mechanism to allow the heated refrigerant to flow to the HSHPH; transferring heat from the refrigerant to air forced through the heat exchanger of the HSHPH and into the compartment in order to maintain the temperature in the compartment; transferring heat from the refrigerant to the PCM of the HSHPH; allowing the refrigerant to flow from the HSHPH back to the outside heat exchanger; and repeating the preceding steps.

According to yet another aspect of the present disclosure, the defrosting cycle comprises: halting the air being drawn through the outside heat exchanger; configuring the 3-way valve or like mechanism, such that the flow of the heated refrigerant to the HSHPH is stopped and redirected back to the outside heat exchanger; allowing the heated refrigerant to transfer heat to condensed moisture (e.g., frost) present on the exterior of the outside heat exchanger; transferring heat from the PCM to the refrigerant present in the heat exchanger of the HSHPH; and transferring heat from the refrigerant in the HSHPH to air forced through the heat exchanger of the HSHPH and into the compartment in order to maintain the temperature therein.

The defrosting cycle may be operated for a predetermined amount of time. This predetermined amount of time may represent the amount of time necessary to deplete all of the stored heat in the PCM or about 1 minute. The defrosting cycle may be conducted when the air temperature outside the compartment is around or near 0° C. and refrigerant temperature is below 0° C., such that during heating operation moisture condenses onto the exterior of the outside heat exchanger (e.g., forms frost). In this scenario, the term “around or near 0° C.” means about 0° C. by ±10° C., alternatively, ±5° C., alternatively, ±2.5° C., alternatively, ±1° C.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of an HVAC system formed according to the teachings of the present disclosure shown in a heating mode;

FIG. 2 is a schematic representation of the HVAC system of FIG. 1 shown in a defrosting mode; and

FIG. 3 is a schematic representation of a Heat Storage Heat Pump Heater (HSHPH) shown from a side-view that is configured for use in a HVAC system according to the teachings of the present disclosure.

The drawings described herein are for illustration purposes only and are not intended to limit the scope of the present disclosure in any way. It should be understood that throughout the description, corresponding reference numerals indicate like or corresponding parts and features.

### DETAILED DESCRIPTION

The following description is merely exemplary in nature and is in no way intended to limit the present disclosure or its application or uses. For example, the heating, ventilation, and air conditioning (HVAC) system containing a Heat Storage Heat Pump Heater (HSHPH) made and used according to the teachings contained herein are described throughout the present disclosure in conjunction with providing heat to a vehicle's cabin, such as that found in an electric vehicle (EV). The incorporation and use of such an HVAC system in other heating, ventilation, air conditioning, and refrigeration applications wherein an HSHPH would be desirable for maintaining temperature in any specified location or compartment is contemplated not to exceed the scope of the present disclosure.

For the purpose of this disclosure, the terms “at least one” and “one or more of’ an element are used interchangeably and may have the same meaning. These terms, which refer to the inclusion of a single element or a plurality of the elements, may also be represented by the suffix “(s)” at the end of the element. For example, “at least one plate”, “one or more plates”, and “plate(s)” may be used interchangeably and are intended to have the same meaning.

For the purpose of this disclosure, the terms “about” and “substantially” are used herein with respect to measurable values and ranges due to expected variations known to those skilled in the art (e.g., limitations and variability in measurements).

Although specific terminology is used herein to describe particular embodiments within the disclosure, this terminology is not intended to limit any portion of the disclosure. For example, as used herein, singular forms of “a”, “an”, and “the” are intended to include various plural forms as well, unless the context of their use clearly indicates otherwise. Terms, such as “comprises”, “includes”, “comprising” or “including” are meant to specify the presence of stated features, integers, steps, operations, elements, and/or components, but are not meant to preclude the presence and/or addition of one or more other features, integers, steps, operations, elements, components, and/or groups associated therewith.

The present disclosure addresses the deficiency of the prior art by providing a design for a heat pump heater configured for heat storage. This stored heating capacity may be used to heat the air provided to a compartment, e.g., the vehicle's cabin, when the HVAC system undergoes a defrosting cycle. This heat pump heater design represents an effective and low cost solution for maintaining cabin comfort.

In general, the Heat Storage Heat Pump Heater (HSHPH) of the present disclosure includes one or more vessels or manifolds configured to store a Phase Change Material (PCM). The PCM represents a substance that absorbs and releases thermal energy (i.e., heat) during the process of melting and freezing. These substances change phases, e.g., reversibly transforms between a solid and a liquid state, during a thermal cycling process. In the present disclosure, the PCM may be an organic (carbon-containing) material or one or more salt hydrates, provided that the PCM is capable of changing phase at a temperature greater than or equal to 24° C. (75° F.); alternatively, >24° C. (75° F.).

An organic (carbon-containing PCM may generally be derived from petroleum, from plants or from animals. Several specific organic PCM compositions include, without limitation, paraffins having at least 18-carbons, lauric acid, methyl palmitate, camiphenilone, docasyl bromide, caprylone, phenol, 9-heptadacanone, p-dichlorobenzene, oxalate, 1-cyclohexylooctadecane, 2-heptadacanone, 3-heptadacanone, hyophosphoric acid, 4-heptadacanone, p-joluidine, cyanamide, hydorcinnamic acid, cetyl acid, a-nepthylamine, camphene, o-nitroaniline, thymol, methyl behenate, diphenyl amine, bees wax, trimyristin, nitro naphthalene, glyolic acid azobenzen, p-bromophenol, durene, alpha napthl, catechol, quinone, actanillide, succinic anhydride, benzoic acid, myristic acid, palmitic acid, stearic acid, acetamide, and methyl fumarate.

Several specific examples of salt hydrates, include but are not limited to, Na₂SO₄·10H₂O, Na₂SiO₃·5H₂O, or mixtures thereof.

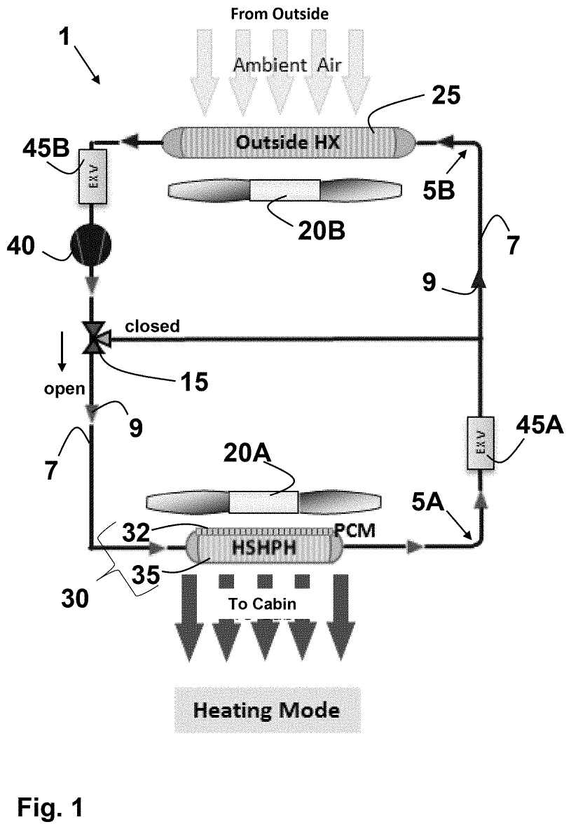

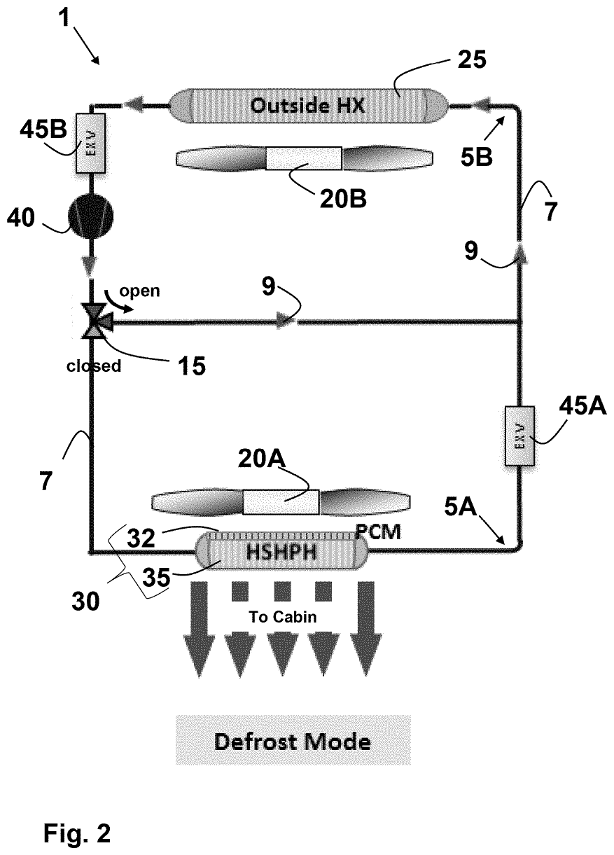

Referring to FIGS. 1 and 2, an example of an HVAC system 1 for maintaining the temperature in a compartment (e.g., a vehicle's cabin) is shown as a schematic highlighting either a heating mode (FIG. 1) or defrosting mode (FIG. 2). This HVAC system 1 generally comprises two thermal loops, namely a heating mode 5A and a defrosting mode 5B used to circulate a refrigerant 10 therein. These two thermal loops 5A, 5B may be placed in parallel with one another as shown in FIG. 1 or 2. One skilled in the art will understand that the two thermal loops 5A, 5B may alternatively, be placed in series with one another without exceeding the scope of the present disclosure. In addition, the thermal loops 5A, 5B may share a portion of the lines or conduits 7, as well as other components through which the refrigerant 9 flows. A valve mechanism 15, such as, but not limited to, a three-way valve, may be utilized to change the flow of the refrigerant 9 through the heating thermal loop 5A (see FIG. 1) or through the defrosting thermal loop 5B (see FIG. 2).

Still referring to FIGS. 1 and 2, the HVAC system 1 comprises an outside heat exchanger 25; wherein ambient air is drawn through the outside heat exchanger 25 by a first blower or fan 20B; one or more refrigerant tubes 7 through which a refrigerant 9 flows; at least one expansion valve 45A, 45B; a compressor 40; a three-way valve 15 or similar mechanism; and a HSHPH 30 as described above and further defined herein. Heated air is forced through the HSHPH 30 and provided to the compartment by a second blower or fan 20A. The HVAC system 1 is configured to undergo a heating cycle and a defrosting cycle, such that the HSHPH 30 provides heat to the compartment during both the heating cycle and the defrosting cycle.

During the heating cycle or mode of the HVAC system 1 as shown in FIG. 1, ambient air from outside is drawn through the heat exchanger 25 by the operation of a blower or fan 20B. The heated refrigerant is passed through an expansion valve 45B (fully open in this mode) and then heated further upon compression via compressor 40. A valve 15 or like mechanism is configured to direct the hot refrigerant discharged from the compressor 40 to the HSHPH 30 in order to heat the air provided to the cabin of the vehicle via the operation of another blower or fan 20A. The PCM 32 in the HSHPH 30 also stores heat energy at the same time. The refrigerant then passes through expansion valve 45A, which is used in this mode to expand the refrigerant prior to it flowing to the heat exchanger 25 for interaction with the ambient air, thereby, starting the sequence of operation over again.

In the defrosting cycle or mode of the HVAC system 1 as shown in FIG. 2, the refrigerant 9 supplied to the heat storage-heat pump heater (HSHPH) 30 is shut off via configuration of a valve 15 or like mechanism, while the blower or fan 20A continues to operate. Thus, during a defrosting cycle, the air that passes through the heat exchanger 35 in the HSHPH 30 absorbs heat from the PCM 32 in order to maintain thermal comfort (e.g., temperature) in the vehicle's cabin. Only in the defrosting cycle or mode is expansion valve 45B utilized for the expansion of the refrigerant. In addition, the defrosting cycle is configured such that hot refrigerant 9 present in thermal loop 5B after the expansion valve 45B and compressor 40 is directed by valve 15 to the heat exchanger 25 in order to defrost the exterior of the heat exchanger 25. During this defrosting cycle the blower or fan 20B used to pull ambient air from the outside through the heat exchanger 25 in the heating mode is not generally operated. However, when desirable, the blower or fan 20B may be turned on towards the end of the defrosting cycle in order to assist in removing any water that has formed or any semi-melted (e.g., slush) ice that remains.

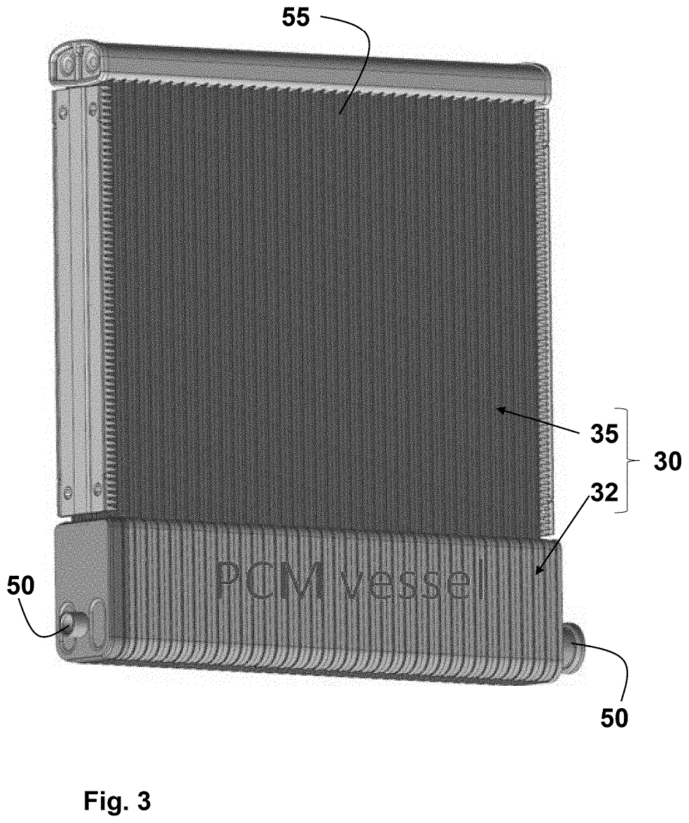

The storage of the PCM 32 associated with the HSHPH 30 may be located in various locations. One possible location for such PCM storage as shown in FIG. 3 is proximate to the bottom of the HSHPH 30. More specifically, FIG. 3 shows the PCM 32 storage to be in a manifold or vessel of the HSHPH 30 located along with the In/Out (I/O) connections 50 near the bottom of the core 55 of the heat exchanger 35. The PCM 32 is placed in between the refrigerant core tubes (not shown) in the core 55 and the I/O connections 50 in the manifold, wherein the refrigerant core tubes are in hydraulic communication with the I/O connections 50 via passages that pass through the PCM 32. In the case of return collectors being at the bottom (not shown), the refrigerant core tubes may be in hydraulic communication with the return collectors via passages passing through the PCM 32. In other words, the PCM 32 in the HSHPH 30 is in thermal communication with the refrigerant 9 flowing through the tubes. One skilled in the art will understand that the phase change material may be stored in other types of storage or locations within the HSHPH 30. For example, without limitation, the phase change material may be located within a PCM cartridge sandwiched between refrigerant tubes and/or air fins with the core of the heat exchanger 35 or within a PCM composite tube or plates used to transport the refrigerant, e.g., in a tube sandwiched by the plates or in a tube-in-tube arrangement without exceeding the scope of the present disclosure.

Referring once again to FIGS. 1 to 3, the phase change material (PCM) 32 in the heating mode absorbs heat from the refrigerant 9 passing through the heat exchanger 35, and stores the heat. When operating in the defrosting cycle or mode, e.g., when the forced refrigerant 9 flow through the outside heat exchanger 25 is off, the heat is transferred from the PCM 32 to the refrigerant 9 in the HSHPH 30 in order to evaporate the refrigerant 9. The evaporated refrigerant 9 rises upwardly through the core tubes in the heat exchanger 35 and releases heat to air blown through the heat exchanger 35, thereby, heating the air and condensing the refrigerant 9. The condensed refrigerant 9 falls downwardly back to the hot PCM 32 storage vessel. This thermal siphon-type operation continues until all of the stored latent heat in the PCM 32 is depleted or the heating demand associated with the short defrosting cycle (typically about 1 minute) is satisfied. A benefit associated with the HSHPH 30 design of the present disclosure is that the PCM 32 storage vessel may be packaged outside the airflow area of the heat exchanger 35, and therefore have no impact on the overall air pressure drop and only a minimum impact on performance of the HVAC system 1.

The refrigerant or a coolant may be any known 2-phase (i.e., liquid/gas vapor) refrigerant. Several examples of refrigerants include, without limitation, a chlorofluorocarbon (CFC), a hydrochlorofluorocarbon (HCFC), a hydrofluorocarbon (HFC), a hydrocarbon (HC), or carbon dioxide. Several specific examples of commercially available refrigerants may include, but are not limited to, R134a, R1234yf, R407c, R410a R12, and R22 refrigerants.

According to another aspect of the present disclosure, a method of maintaining temperature in a compartment is provided as previously described above and further defined herein. This method generally comprises providing an HVAC system that includes an HSHPH; allowing the HVAC system to undergo a heating cycle; and allowing the HVAC system to undergo a defrosting cycle, such that the HSHPH provides heat to the compartment during both the heating and defrosting cycles.

According to another aspect of the present disclosure, a vehicle is provided that includes an HVAC system containing the heat storage-heat pump heater (HSHPH) as described above and further defined herein. This vehicle may be an electric vehicle (EV) powered by a battery pack.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A heat storage heat pump heater (HSHPH) for use in a heating, ventilation, and air conditioning (HVAC) system to maintain temperature in a compartment, the HSHPH comprising:
a heat exchanger having an inlet and an outlet located in one or more manifolds and a core that includes one or more refrigerant tubes through which a refrigerant flows and a plurality of fins that extend between the tubes, the one or more refrigerant tubes being in fluid communication with the inlet and the outlet; and
a phase change material (PCM) configured to store heat transferred from the refrigerant during a heating cycle and to transfer heat to the refrigerant during a defrosting cycle;
wherein the HSHPH provides heat to the compartment during both the heating cycle and the defrosting cycle in order to maintain the temperature in the compartment.

2. The HSHPH according to claim 1, wherein the PCM changes phase at a temperature that is greater than or equal to 24° C.

3. The HSHPH according to claim 2, wherein the PCM is an organic material or a salt hydrate.

4. The HSHPH according to claim 1, wherein the refrigerant is a 2-phase refrigerant and the HSHPH is configured to undergo a thermal siphon-like operation during the defrosting cycle until all of the stored heat in the PCM is depleted or until the defrosting cycle is completed.

5. The HSHPH according to claim 1, wherein the PCM is located between the refrigerant tubes in the core and the inlet and/or outlet in the one or more manifolds, such that the PCM is in thermal communication with the refrigerant flowing through the refrigerant tubes.

6. The HSHPH according to claim 1, wherein the PCM is located in a cartridge sandwiched between the refrigerant tubes and/or fins in the core of the heat exchanger, such that the PCM is in thermal communication with the refrigerant flowing through the refrigerant tubes.

7. The HSHPH according to claim 1, wherein the PCM is located in a composite tube or in composite plates, such that the composite tube surrounds at least a portion of the refrigerant tubes or the composite plates sandwich at least a portion of the refrigerant tubes;
wherein, the PCM is in thermal communication with the refrigerant flowing through the refrigerant tubes.

8. The HSHPH according to claim 1, wherein the PCM is located outside the airflow area of the heat exchanger and does not affect overall air pressure drop associated with the heat exchanger.

9. An HVAC system for maintaining temperature in a compartment; the HVAC system comprising:
one or more refrigerant tubes through which a refrigerant flows;
an outside heat exchanger; wherein ambient air is drawn through the outside heat exchanger by a first blower or fan;
at least one expansion valve;
a compressor;
a three-way valve; and
a HSHPH according to claim 1; wherein heated air is forced through the HSHPH and provided to the compartment by a second blower or fan;
wherein the HVAC system is configured to undergo a heating cycle and a defrosting cycle, such that the HSHPH provides heat to the compartment during both the heating cycle and the defrosting cycle.

10. The HVAC system according to claim 9, wherein during the heating cycle the 3-way valve is configured to allow refrigerant to flow from the at least one expansion valve and the outside heat exchanger through the compressor to the HSHPH in order to heat the air provided to the compartment and to transfer heat to the phase change material (PCM).

11. The HVAC system according to claim 9, wherein during the defrosting cycle, the 3-way valve is configured to allow the refrigerant to flow from the outside heat exchanger through the at least one expansion valve, compressor, and back to the outside heat exchanger, such that the flow of refrigerant by-passes or is stopped from flowing to the HSHPH.

12. The HVAC system according to claim 11, wherein during the defrosting cycle, the PCM transfers heat to air that passes through the heat exchanger in the HSHPH in order to maintain the temperature in the compartment.

13. The HVAC system according to claim 9, wherein the refrigerant is a 2-phase refrigerant and the HSHPH is configured to undergo a thermal siphon-like operation during the defrosting cycle until all of the stored heat in the PCM is depleted or until the defrosting cycle is completed.

14. The HVAC system according to claim 9, wherein the compartment is a cabin in an electric vehicle (EV).

15. A method of maintaining temperature in a compartment; the method comprising:
providing an HVAC system that includes an HSHPH;
allowing the HVAC system to undergo a heating cycle; and
allowing the HVAC system to undergo a defrosting cycle;
wherein the HSHPH provides heat to the compartment during both the heating cycle and the defrosting cycle;
wherein the HSHPH comprises:
a heat exchanger having an inlet and an outlet located in one or more manifolds and a core that includes one or more refrigerant tubes through which a refrigerant flows and a plurality of fins that extend between the tubes, the one or more refrigerant tubes being in fluid communication with the inlet and the outlet; and
a phase change material (PCM) configured to store heat transferred from the refrigerant during the heating cycle and to transfer heat to the refrigerant during the defrosting cycle.

16. The method according to claim 15, wherein the heating cycle comprises:
drawing ambient air through an outside heat exchanger, such that heat is transferred to a refrigerant flowing there through;
allowing the refrigerant to flow through an expansion valve and a compressor in order to further heat the refrigerant;
configuring a 3-way valve to allow the heated refrigerant to flow to the HSHPH;
transferring heat from the refrigerant to air forced through the heat exchanger of the HSHPH and into the compartment in order to maintain the temperature in the compartment;
transferring heat from the refrigerant to the PCM of the HSHPH;
allowing the refrigerant to flow from the HSHPH back to the outside heat exchanger; and
repeating the preceding steps.

17. The method according to claim 16, wherein the defrosting cycle comprises:
halting the air being drawn through the outside heat exchanger;
configuring the 3-way valve, such that the flow of the heated refrigerant to the HSHPH is stopped and redirected back to the outside heat exchanger;
allowing the heated refrigerant to transfer heat to condensed moisture present on an exterior surface of the outside heat exchanger;
transferring heat from the PCM to the refrigerant present in the heat exchanger of the HSHPH; and
transferring heat from the refrigerant in the HSHPH to air forced through the heat exchanger of the HSHPH and into the compartment in order to maintain the temperature therein.

18. The method according to claim 15, wherein the defrosting cycle is operated for a predetermined amount of time;
wherein the predetermined amount of time represents the amount of time necessary to deplete all of the stored heat in the PCM or 1 minute.

19. The method according to claim 15, wherein the defrosting cycle is conducted when the air temperature outside the compartment is around 0° C., such that moisture condenses onto the exterior of the outside heat exchanger.

20. The method according to claim 15, wherein the compartment is a cabin in an electric vehicle (EV).
